(19) United States
(12) Patent Application Publication
(10) Pub. No.: US 2003/0067703 A1
(43) Pub. Date: Apr. 10, 2003

(54) Data storage cartridge with sensor

(76) Inventors: Stephen Anthony Holmes, Malmesbury Wilts (GB); Christopher Huw Williams, Monmouth (GB); Allan Hodkinson, Bristol (GB)

Correspondence Address: LOWE HAUPTMAN GILMAN & BERNER, LLP, 1700 Diagonal Road, Suite 300, Alexandria, VA, 22314, US

(21) Appl. No.: 10/251,983

(22) Filed: Sep. 23, 2002

(30) Foreign Application Priority Data
Sep. 21, 2001 (GB) 0122912.9

(51) Int. Cl. G11B 15/18

(52) U.S. Cl. 360/69

(57) ABSTRACT

There is disclosed a medium cartridge comprising: a casing; a data storage medium for storing data; and at least one shock sensor for sensing a shock condition experienced by said medium cartridge.

### FIELD OF THE INVENTION

The present invention relates to the field of data storage.

### BACKGROUND TO THE INVENTION

In order to store digital electronic data, it is known to use magnetic tape data storage cartridges which are inserted into a tape drive unit having a plurality of read/write heads. Typically, such magnetic tape data storage devices may be used to back-up data generated by a host device such as a computer. Additionally, in order to improve ease of access to data recorded on tape, it is known to include a solid state memory device in some cartridges and to store in this memory information relating to, for example, a listing of the contents of the tape. An example of a prior art media cartridge 100 is schematically illustrated in FIG. 1. A suitably configured tape drive is configured to read and/or write to a tape inside casing 100 via entry through dust flap 101.

The prior art tape data storage cartridge 100 as shown in FIG. 1 comprises: a case; automation notches; handling notches; a write inhibit mechanism; a single reel for storing magnetic tape; a locking mechanism for the reel; a magnetic tape wound on the hub of the reel; a leader pin; a parking mechanism for the leader pin; a door; and a memory device located within the casing. A standards activity is currently on-going to define the concept of having a memory associated with a given media as “media auxiliary memory (MAM)”. However, the standard being developed is only concerned with looking at the logical format of the memory and not the physical aspect. Within certain linear tape open formats, as used by Hewlett Packard for example, media cartridges having memory devices within the cartridge, are known as LTO-CM (linear tape open-cartridge memory) which is an ECMA standard—ECMA319. Before the tape is inserted into a tape drive, the tape is usually wound fully onto a reel inside the cartridge and so to access data on an end of the tape nearest the reel, the tape may be required to be substantially fully wound out of the cartridge and onto a second reel of the tape drive mechanism. Before the cartridge is removed from the tape drive, the tape must be fully rewound back onto the reel inside the cartridge. Dual reel cartridges are also known, but these are not “picked” in the same way and do not generally suffer from the problem of picking the tape correctly so as to locate a correct starting position. Memory devices associated with cartridges of the type illustrated in FIG. 1 are generally positioned near a periphery of the casing and within the casing such that as the cartridge is inserted into a suitably configured tape drive unit, signals can be read and written to the memory device by inductive coupling.

Unfortunately, media cartridges such as those described may be damaged during their lifetime. For example, one cause of failure today for tape drives is a dropped piece of media. The media dropped, or exposed to excessive vibration for example, may upon insertion in a tape drive result in the tape drive attempting to “pick” up the tape media which thereafter becomes entangled in the tape drive due to the tape media being out of it's expected position.

When a media cartridge is dropped, the leader pin can be displaced, and tape backing is disturbed. When the media cartridge is loaded into a drive, the tape and/or media cartridge may therefore jam, and cause the drive to fail.

Entanglement of this kind commonly causes damage to the tape drive thereby making it inoperable. Tape drive damage caused in this way is particularly a problem in tape library environments, of the type schematically illustrated in FIG. 2, where it is possible for a dropped piece of media to enter the library and cause problems to multiple tape drives before an end user or application detects that this “bad” piece of media is causing the problem.

Referring to FIG. 2 herein, tape library environment 200 comprises a tape reader/writer device 201 having control means 202 which is configured to enable a user of drive 201 to be able to determine the functions to be performed by the drive. Drive 201 is operated in conjunction with a tape library 203 which, in the example shown, comprises a rack of tape cartridges 204 and a robotically controlled arm 205 which is configured to move along rails 206. Thus, in operation drive 201 is configured to effect fetching of tape cartridges 204 via use of robotic arm 205, robotic arm 205 being operated under the control of a microprocessor located within drive 201 as is known to those skilled in the art. Thus, in relation to the cartridge detailed in FIG. 1 it may, in general, be difficult to determine whether the cartridge has in fact been damaged in some way.

One problem to be solved is how to establish whether or not a given cartridge has been damaged by way of it having experienced a substantial mechanical shock.

The costs incurred by companies selling tape drives is thought to be much greater than necessary due to the damage to tape drives caused by cartridges which cause problems such as entanglement. It is difficult to determine whether or not a given cartridge was faulty or inadvertently damaged in some way by the owner. Thus, who should absorb the cost of the damaged drive is often at issue. Similarly, for the user of a cartridge it is highly desirable to reduce the instance of tape drive failure through incorrectly operating cartridges of one kind or another.

Media cartridges having different types of media are also known in the art, including removable hard disk drives, containing rotatable magnetic disks. In this case, there is no risk of entanglement of media with a drive unit, although a malfunctioning removable hard disk cartridge can still cause problems. Where there is a problem in reading or writing data, the problem can either be the drive unit, or the media cartridge. A problem with a media cartridge can easily be attributed to a correctly functioning drive unit, thereby incurring a service call out on the drive unit, when in reality none is necessary since it is the media cartridge which is malfunctioning. However, faults in a media cartridge can be difficult to attribute to the cartridge rather than a drive unit, particularly where a fault is intermittent or occurs only under infrequently occurring conditions.

Customers of high performance data storage systems often demand very high standards of integrity for their data, despite the operating or storage conditions of the media concerned. Suppliers of data storage systems have a class of customers who are exceptionally sensitive to data loss. These customers have particular demands for data storage media, i.e. that any data stored on the media should not be lost. In the context of linear tape open format media, customers, and in particular library customers, can damage cartridges for example by dropping them, such that subsequent insertion of a cartridge into a tape drive device or library device may irreversibly damage the tape, the tape drive or both resulting in loss of data.

There is therefore a need to provide a media cartridge which can be identified as having been dropped, in a manner which can warn a user against loading a media cartridge into a tape drive device or library device, before additional damage to the cartridge is incurred through the library device or tape drive device.

In view of the above, there is clearly a need to provide apparatus and methods which aid in identifying cartridge malfunctioning.

An object of the present invention is to provide a new and improved media cartridge designed to reduce the incidents of data storage device malfunction through inadvertent use of damaged media cartridges.

Another object is to provide a new and improved media cartridge and method of operating same such that a user of the media cartridge can determine whether the media cartridge is faulty or is likely to be faulty.

A further object of the present invention is to provide a new and improved media reader device which is able to determine whether or not a given media cartridge has experienced an adverse environmental condition.

A further object of the present invention is to provide a new and improved media cartridge which is arranged to signal whether or not it has experienced an adverse environmental condition.

### SUMMARY OF THE INVENTION

According to one aspect of the present invention there is provided a media cartridge comprising:

a casing; and

a data storage medium for storing data; and

at least one shock sensor for sensing a shock condition experienced by said media cartridge.

In one aspect of the invention, an accelerometer is fitted into a media cartridge during manufacture. In one embodiment, the accelerometer is a solid state accelerometer arranged to cause an electrical break in response to a threshold G-force having been experienced by the media cartridge. While the media cartridge is inserted into a tape drive device, the tape drive interrogates the accelerometer in the media cartridge to determine if the cartridge has experienced an excessive G-force. Interrogation can be performed by a suitably configured transceiver which communicates with the cartridge via a hard wired electric circuit or a wireless link.

In another embodiment, the accelerometer includes a breakable conductive strip. When the cartridge is dropped and experiences a shock over a predetermined shock, the conductive strip breaks. Breaking of the conductive strip is sensed by a memory device in the cartridge, which, when interrogated by a drive unit for media in the cartridge, generates, on the drive unit, an alert message that the media cartridge has been subjected to a shock. The drive unit can then enter a recovery mode, before attempting to read a data storage media in the cartridge, which could result in jamming the drive unit.

Specific apparatus and methods described herein are concerned with media cartridges for use with data reading devices. A data reading device can be incorporated into a data storage device, or into a library device such as a storage rack for storing media cartridges. An example of a media cartridge concerns magnetic tape data storage cartridges which are commonly used in computer back-up and/or in conjunction with tape recording/writing devices having a substantially static read/write head in which an elongate tape is drawn past the head at relatively high speed, for example of the order of 3 meters per second. The apparatus and methods apply to a whole variety of media cartridges including both single reel and dual reel magnetic tape data storage cartridges, magnetic random access memory (MRAM) cartridges, which are removable from a data storage device, removable hard disk drive units, having a rotating magnetic disk, and other data storage media cartridges which are removable from a data storage device. As those skilled in the art will appreciate, removable media cartridges are subjected to a greater risk of shock damage than data storage media which remain in a computer system. Thus the scope of the invention is intended to cover removable disks, removable tapes, cartridges and removable MRAM devices. Types of disks covered include CD ROMS, magnetic disks and optical disks for example.

The specific methods and apparatus described herein are suitable for tape media for use with recording devices where a tape is permanently stored within the cartridge, and in which the cartridge is removable from the tape drive mechanism. For data storage media other than magnetic tape, tape tangling is not a problem. However, as those skilled in the art will realize it is still highly desirable to be able to determine whether or not an adverse condition has been experienced by a given data storage medium prior to using the data storage medium in a suitably configured reader.

In the following description, numerous specific details are set forth in order to provide a thorough understanding of the present invention. It will be apparent however, to one skilled in the art, that the present invention may be practiced without limitation to these specific details. In other instances, well known methods and structures have not been described in detail so as not to unnecessarily obscure the present invention.

In this specification and the claims, the term “data storage device” includes a device capable of reading and/or writing data to a data storage media cartridge. A data storage device is capable of engaging a data storage media cartridge for transfer of data between the data storage device and the data storage media cartridge. A data storage device is capable of transferring data with a plurality of individual data storage media cartridges, either in parallel at a same time, and/or sequentially one after another.

In this specification and the claims, the term “data storage media cartridge” includes any data storage media which, in normal use, provides for self contained storage of data, and can be stored or kept independently of a data storage device. Data can be read and/or written to a data storage media cartridge using a data storage device. The data storage media cartridge is engageable with one or more different data storage devices at different times, and is removable from each data storage device. The term media cartridge is to be construed as having a meaning equivalent to a data storage media cartridge.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 illustrates schematically a tape data storage cartridge 100 having a memory for storing information concerning signals recorded on the recording medium such as a magnetic tape;

FIG. 2 illustrates schematically a prior art data storage media reader/writer device with an automated data storage medium library having a rack and shelf arrangement for storing tapes, the tapes being accessible by a computer controlled robotic tape selection device;

FIG. 3 illustrates schematically a tape data storage cartridge comprising a sensor as configured in accordance with a first preferred embodiment of the present invention;

FIG. 4 further details, in exploded view, the sensor identified in FIG. 3;

FIG. 5 and FIG. 6 further detail the sensor unit of FIG. 3 and FIG. 4, the unit comprising a MEMS accelerometer;

FIG. 7 illustrates schematically a second preferred embodiment of a shock detection sensor, as configured for use in a media cartridge;

FIG. 8 illustrates schematically a further preferred embodiment of a media cartridge configured with a sensor;

FIG. 9 illustrates schematically, in accordance with the present invention, a reader device configurable for writing data to and reading information, including sensor information, from a magnetic tape data storage cartridge of the type detailed in FIG. 3;

FIG. 10 illustrates schematically, in accordance with the present invention, an alternative representation of the preferred embodiment of the tape data storage cartridge of FIG. 3 comprising a condition sensor for detecting whether or not the cartridge has experienced an adverse condition;

FIG. 11 illustrates schematically, in accordance with the present invention, processing steps performed by the media cartridge information reader of FIG. 9 and comprises a step for processing sensor derived information stored by one or more sensors associated with the cartridge;

FIG. 12 further details a sensor interrogation step identified in FIG. 11; and

FIG. 13 and FIG. 14 illustrate schematically two exemplary messages on a display screen of a tape drive as configured in accordance with a preferred embodiment of the present invention, the displays respectively indicating to a user that a given media cartridge under consideration is either suitable or not suitable for safe further use;

FIG. 15 illustrates schematically a further preferred embodiment of a media cartridge as configured in accordance with the present invention; and

FIG. 16 illustrates schematically a further preferred embodiment of a shock detection sensor, as configured for use in a media cartridge in accordance with the present invention, the figure also illustrating schematically a reader device for reading a cartridge memory.

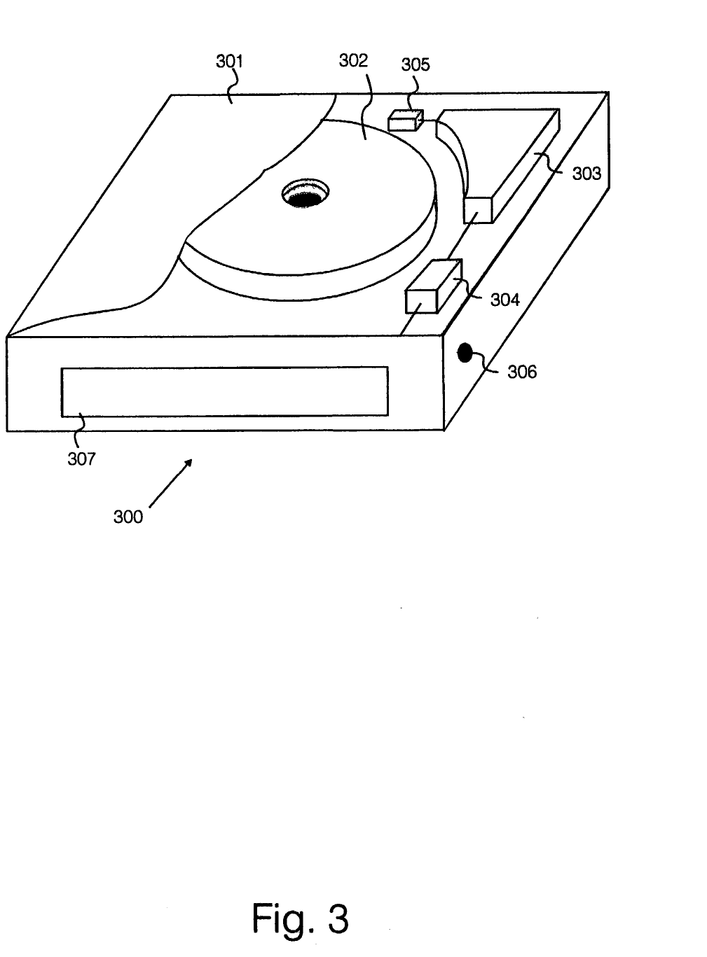

### DETAILED DESCRIPTION OF FIGS. 3-16

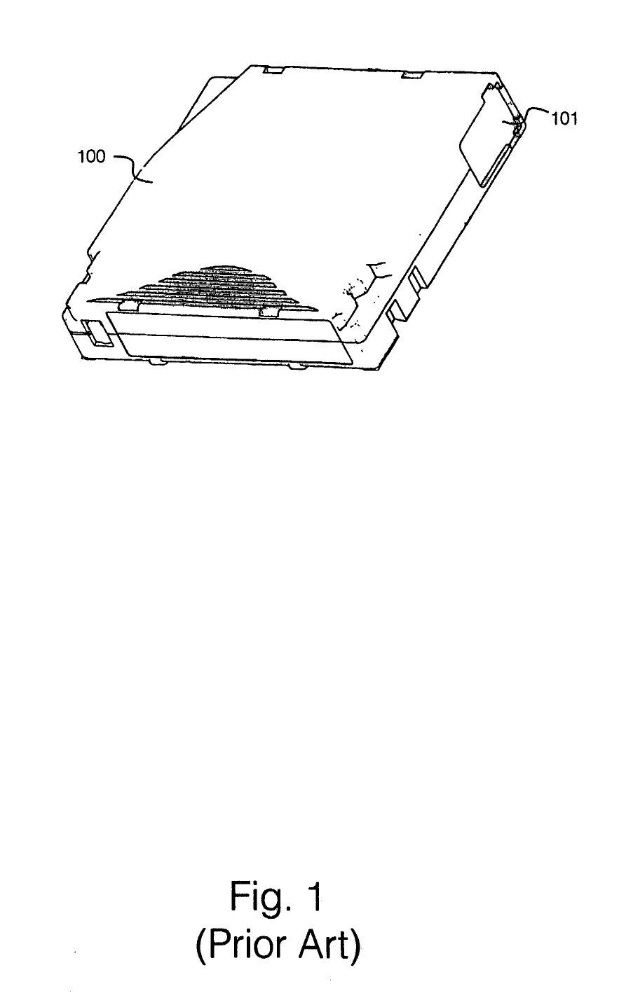

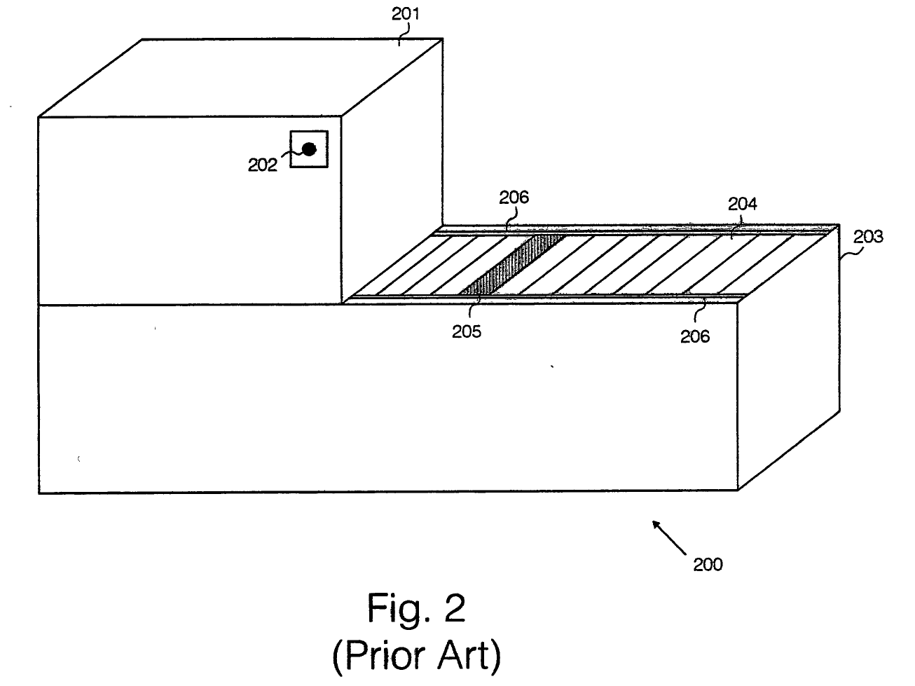

In the improved schematically illustrated tape media cartridge according to FIG. 3, tape media cartridge 300 comprises a casing 301 and magnetic tape data storage medium 302 which is rotatable about an axle and which comprises all, or most of, the features of the cartridge illustrated in FIG. 1. In particular, media cartridge 300 comprises a transponder unit 303 which is electrically connected to cartridge memory 304. Memory 304 may suitably comprise an Electrically Erasable Programmable Read Only Memory (EEPROM). As is known to those skilled in the art, a transponder memory device 304, incorporated within the media cartridge, can be inductively powered and signals can be received and sent between a tape drive reader/writer and the transponder 303. Power can be delivered to the memory 304 and transponder unit 303 via power source delivery device connection point 306 as an alternative to the non-inductive method. Media cartridge 300 additionally comprises dust flap 307 which can be hinged to allow a suitably configured media reader to access media cartridge 300 and perform picking of the tape for reading stored information. Media cartridge 300 additionally comprises one or more sensors, such as sensor 305, which can suitably be in electrical communication with both memory 304 and transponder 303. Sensor 305 comprises a shock detector which may be in the form of a suitably configured accelerometer. However, a sensor could be selected to detect other environmental conditions experienced by the device, such as excessive dampness or temperature above or below certain levels. Where sensor 305 comprises a shock detector, the sensor is arranged to sense when the cartridge is exposed to a shock such as the cartridge being dropped to experience certain gravitational forces. The sensor can be pre-calibrated to sense shocks or decelerations above a threshold level or in a given range between predefined lower and upper limits.

The shock detection sensor 305 of FIG. 3 can have various forms as now described.

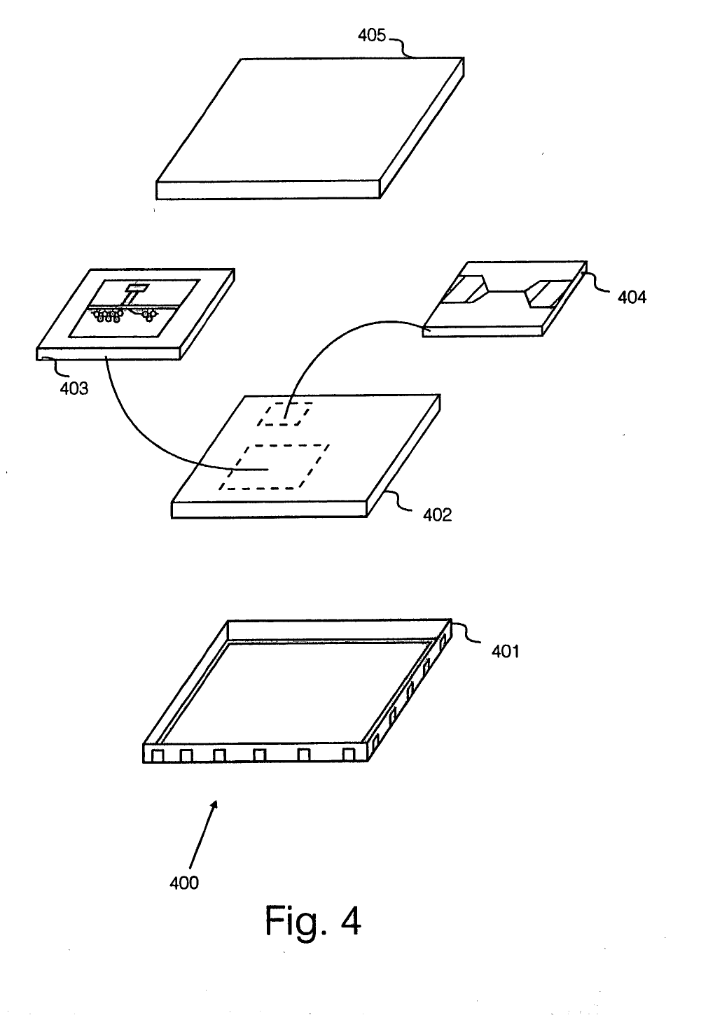

FIG. 4 is an illustration of a known shock detection sensor 400 which can be affixed within a media cartridge 300. An example of a manufacturer specializing in miniature accelerometer type devices is Silicon Designs Inc. (SDI) which manufactures reliable capacitance acceleration non-silicon MEMS nickel based sensors. Accelerometers of varying sensitivity are available from less than one g to over 20,000 g. The standard range comprises 2 to 1,000 g. A capacitance change arising through an acceleration (or deceleration) is used as the sensed parameter to provide several benefits as compared with piezoresistive sensors which are used in various other kinds of accelerometers. Those skilled in the art will realize the benefits of capacitance based MEMS accelerometers and furthermore will readily understand how these devices work. One particular advantage of capacitive sensing is that it allows for responses to DC accelerations and dynamic vibration. This clearly has advantages in respect of use of an accelerometer in a media cartridge since both excessive vibration and shock through dropping may effectively damage the workings of a cartridge. FIG. 4 is a schematic illustration of an example of such a MEMS accelerometer which comprises a substantially square shaped ceramic chip carrier unit 401 which can be directly fixed to a suitably configured circuit board. Unit 401 can be attached to a PCB (Printed Circuit Board) via standard die attach and gold wire bonding techniques together with solder sealing so as to provide a simple fully hermetic device. Unit 401 fixedly carries a blank substrate 402 upon which are electrically connected a suitably configured electronic chip 403 and a sense element chip 404, elements 402-404 being protected from above by a lid 405.

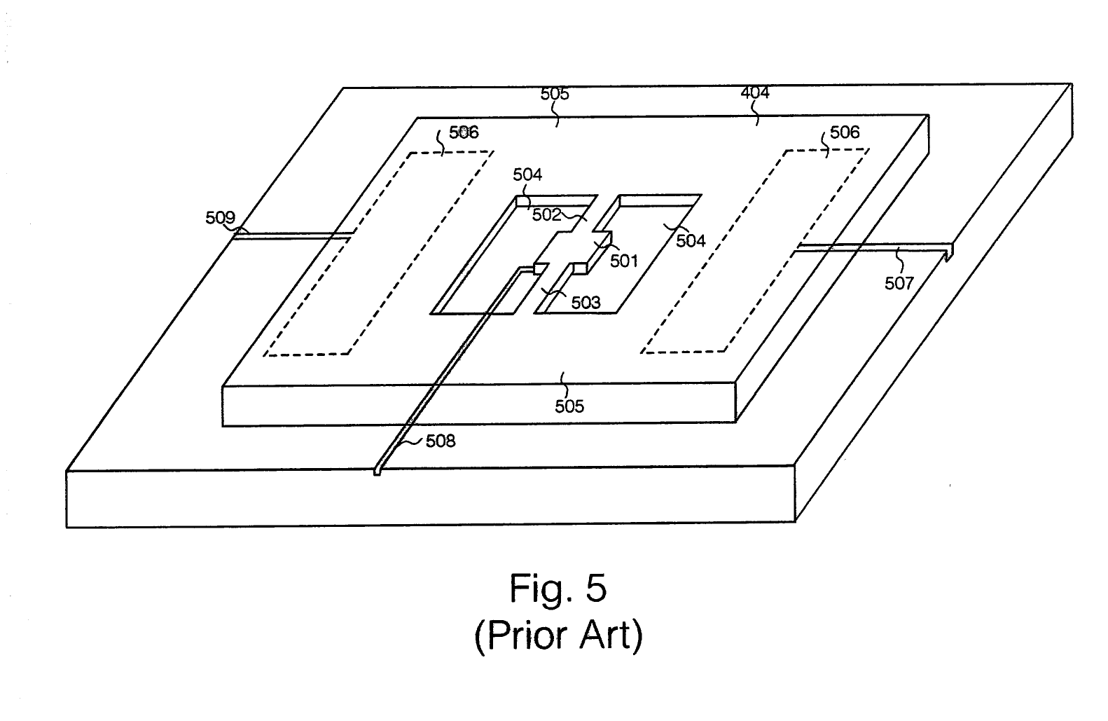

Details of the micro-machined sense element chip 404 as placed on substrate 402 are illustrated in FIG. 5. Sensor chip 404, as is known to those skilled in the art of sensor chip design, comprises central pedestal support 501 from which extend torsion bars 502 and 503. Torsion bars 502 and 503 are located on opposite sides of pedestal support member 501. Torsion bars 502 and 503 are thus respectively connected to the remainder of chip 404 which comprises a substantially square shaped member surrounding the pedestal region around a slotted portion 504 along the respective sides of the torsion bars. Thus, a slotted portion 504 acts as a space between the torsion bar/pedestal arrangement and the outer solid periphery of the chip. Each of the outer solid periphery regions on each respective side of the torsion bars comprises an upper, mobile capacitor plate 505 which is positioned above a lower, fixed capacitor plate 506 formed on the substrate 402. Electric contacts of the capacitor plates 505 and 506 with other electric components are formed by electrical connection arrangements (such as electrical connection lines 507, 508 and 509) located on the substrate. The substrate conductive capacitor plate 506 is formed of two conductive capacitor plates which are symmetrically located on each side of the longitudinal axis of the torsion bars. In operation, the device forms a fully active capacitance bridge as those skilled in the art will understand. Sense element plate 404 is configured to rotate about a longitudinal axis passing through the torsion bars thereby reducing the average distance between one side of element 404 and the respective lower fixed capacitor plate 506, to increase the capacitance for that capacitor plate. However, the distance to the other plate of the capacitance is increased, thereby decreasing the capacitance of the capacitor. The dimensions of sense element are typically approximately 1,000 microns by 600 microns; plate 404 typically has a thickness of 5-10 microns. As will be known to those skilled in the art, a spacing between plate 404 and substrate 402 of about 5 microns results in a capacitance from plate 404 to each lower capacitance plate of about 0.15 pF. In operation, the torsion bar arrangement causes a change in capacitance which is suitably calibrated with the force required to effect a certain torque upon torsion bars 502, 503.

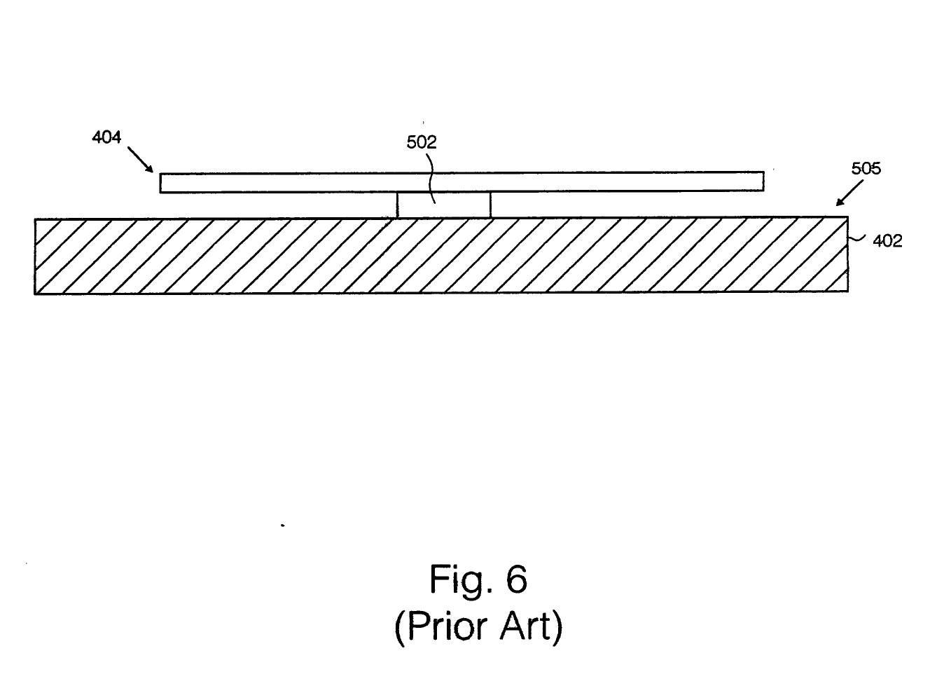

FIG. 6 is a schematic illustration of an end sectional view of the arrangement of FIG. 5 showing central pedestal 502 supporting rotating plate member 404 above substrate 402.

Although the MEMS accelerometer, schematically illustrated in FIGS. 4-6, is suitable for enabling a given shock to be detected and recorded, the cost of such a device could be further reduced through creation of a simpler device calibrated to give a “simple” fuse-type operation. Those skilled in the art will realize that MEMS accelerometers also have a rating for withstanding shock. A simpler MEMS accelerometer operating as a detector for a shock over a certain threshold (fuse-type operation) would allow for an increase in the shock rating for such devices. As those skilled in the art will realize MEMS accelerometers are usually constructed to withstand a high threshold of shock. However, depending upon the application, an accelerometer can be configured to operate at a wide range of desirable threshold levels. Therefore, an accelerometer having a suitable shock rating for the type of conditions of concern in the present application (dropping data media cartridges and the like) can be readily configured. The exact shock rating required for a given media depends upon various requirements by manufacturers and customers, such as on the casing material, or the presence of any impact reducing devices within a given storage medium. Those skilled in the art will realize that a threshold based MEMS accelerometer device can easily be configured since it would comprise simplified electronic circuitry as compared with the device illustrated in FIGS. 4-6.

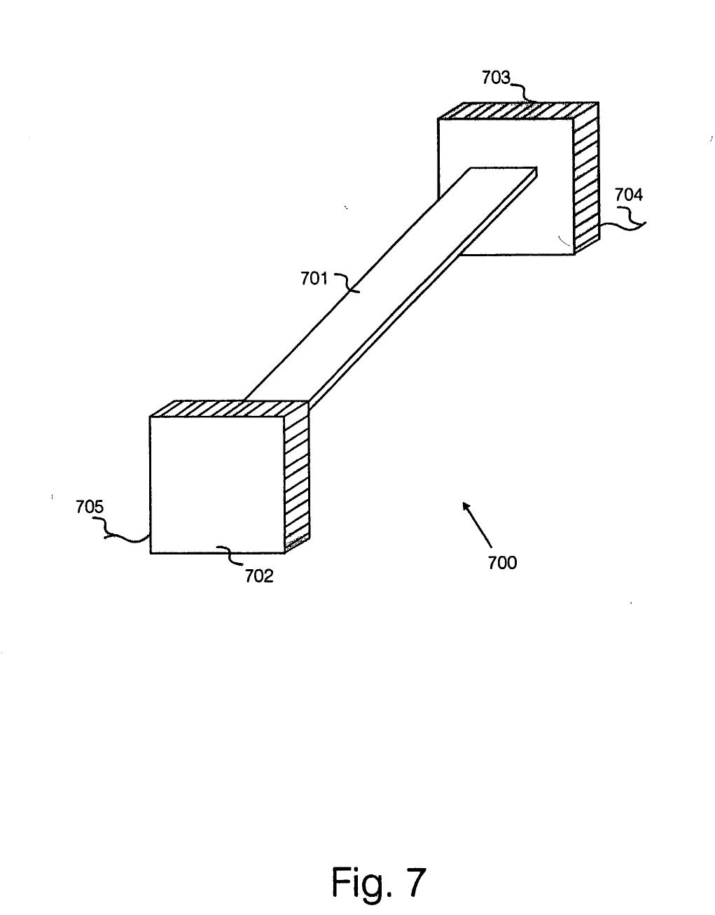

FIG. 7 herein is a schematic illustration of another shock detection sensor configured for use in a media cartridge.

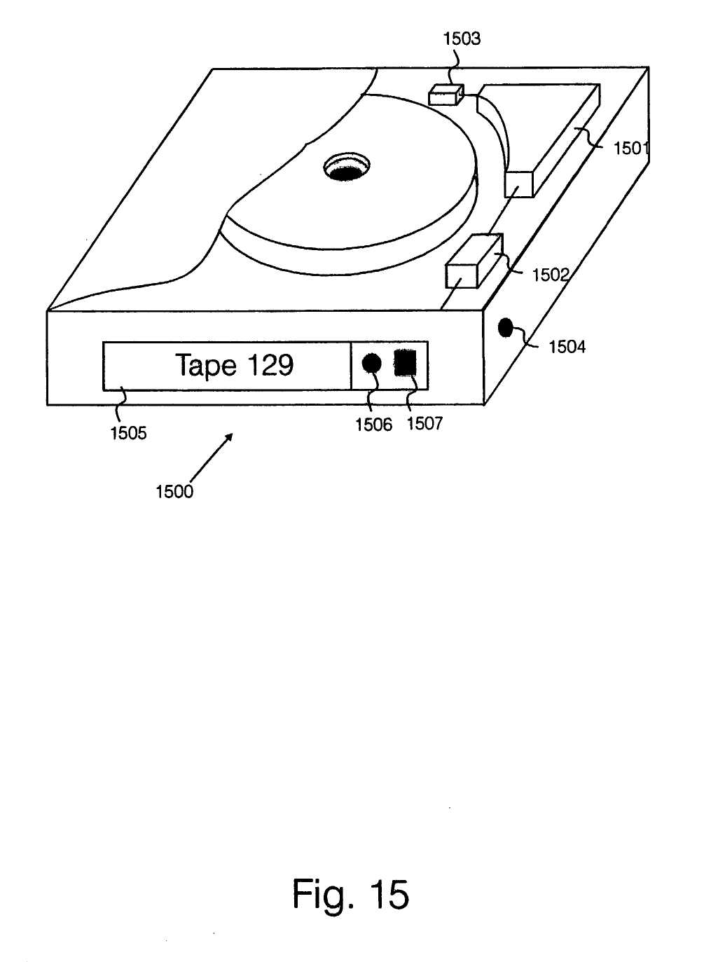

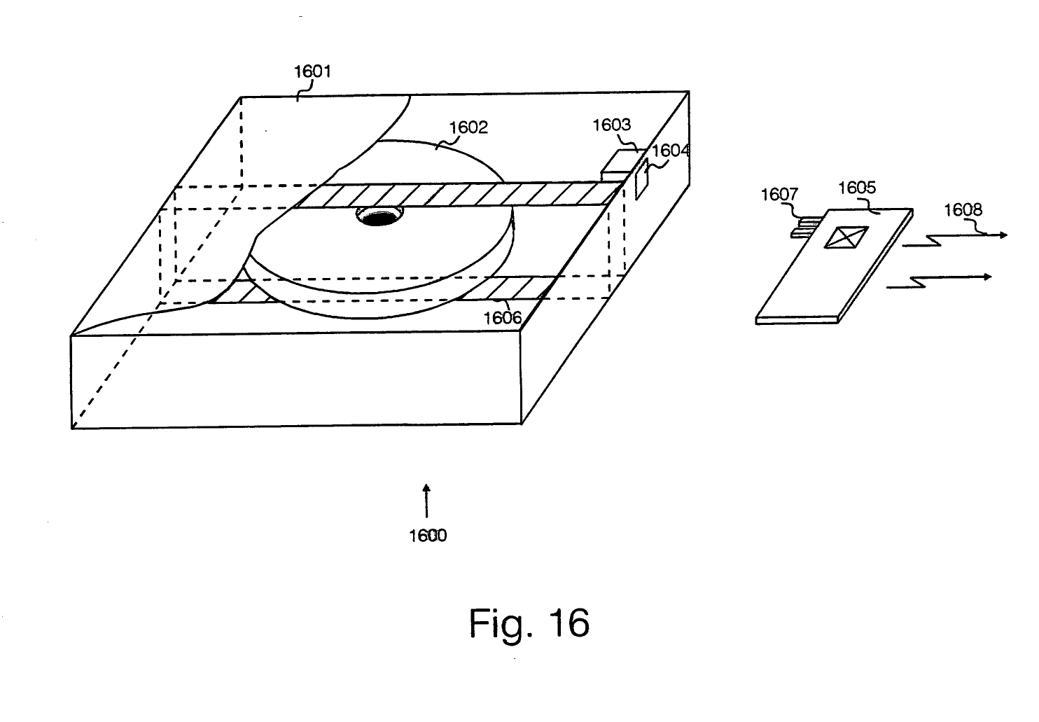

The sensor illustrated in FIG. 7 comprises a conducting strip device 700 which, is affixed inside a media cartridge. Device 700 comprises a conducting strip 701, such as an electrically conducting metallic foil. The strip 701 is configured to extend across a portion of the cartridge, such as towards one of the sides of the magnetic reels. Foil strip 701 is supported, for example, by casing wall portions 702 and 703 located at each end. Opposite ends of strip 701 are electrically connected to a memory device via electrical connectors 704 and 705 respectively. Thus, in operation and in the event of a media cartridge experiencing an external shock force causing the casing of the cartridge to be deformed, or at least be heavily vibrated on impact. The strip is cracked or damaged resulting in breaking of the electrical connection. A suitably configured cartridge memory thereafter then stores information or an indication representing a change in the electrical configuration of the device of FIG. 7. Thereafter the cartridges memory relays this information/indication to a suitably configured media cartridge reader (or possibly to a reader device located within the cartridge itself as discussed later in relation to FIG. 15). One arrangement for an electrically conducting strip is described later in relation to FIG. 16.

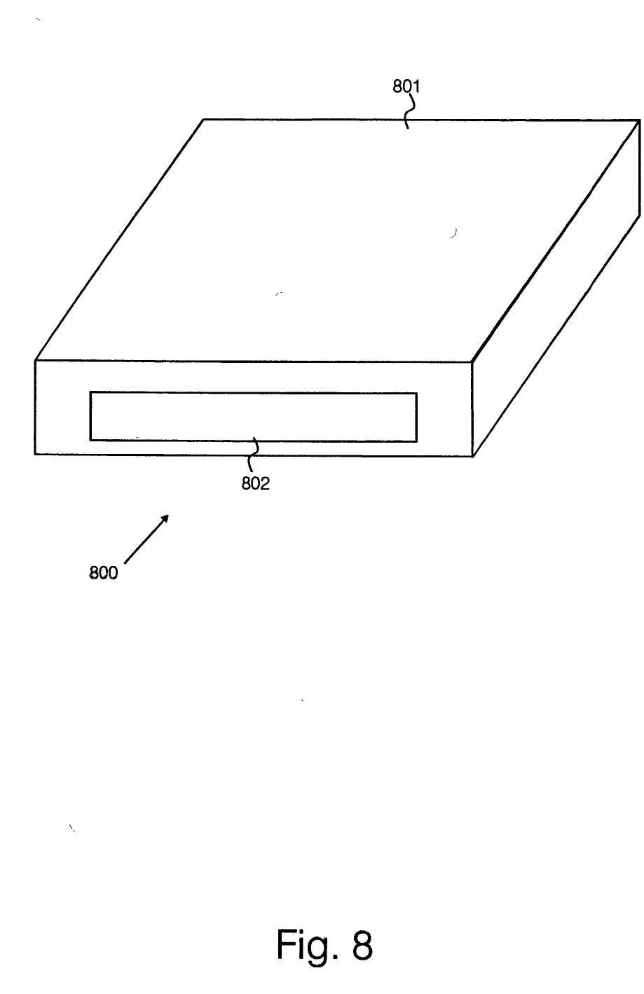

FIG. 8 is a schematic illustration of a media cartridge 800 configured with a sensor. The cartridge 800 comprises a conventional magnetic cartridge or another form of data storage cartridge having a casing 801. Cartridge 800 comprises at least a data storage media inside the cartridge, a dust flap for enabling entry to the media storage medium, and an internal or external sensor 802 configured in the form of an adherent (stick on) label. Such a sensor is configured to detect a change in an environmental condition, such as humidity. As those skilled in the art will realize, various stick on label devices are available for detecting changes in environmental conditions (such as humidity and temperature) whereby a color change or another readily identifiable change in the label is realized. It is known to use various kinds of crystals which change color depending on environmental conditions to which they are subjected. Crystals are also known which change color if a certain shock force or acceleration is experienced.

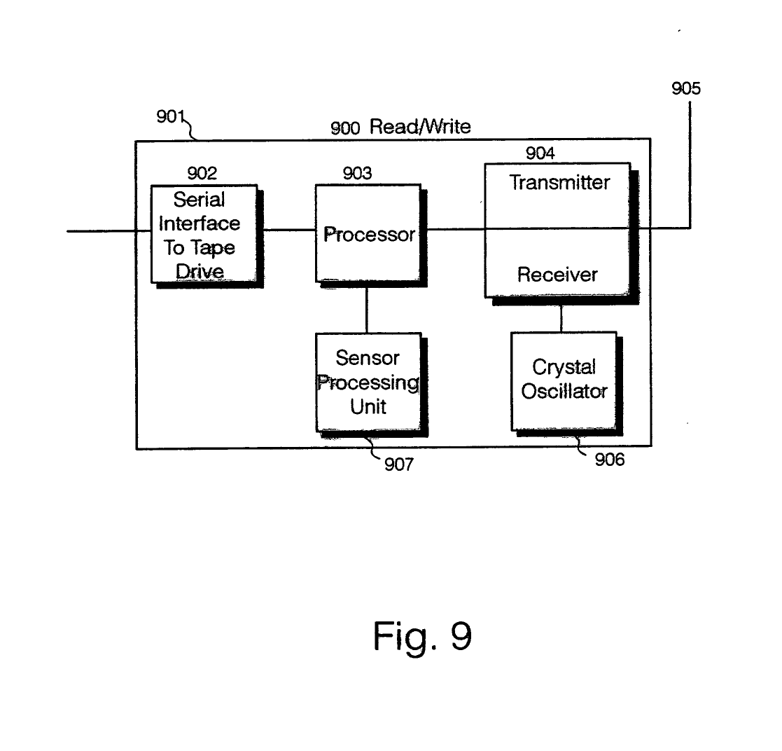

FIG. 9 is a schematic illustration of a read/write device 900 configurable to be used in conjunction with a cartridge of the type described in connection with FIG. 3. It is to be realized that the read/write devices can be replaced by other structures, such as read only or write only devices. In the example shown, read/write device 900 comprises a casing 901 and a serial interface 902 to a tape drive. Information from a suitably attached tape drive is passed via unit 902 to processor 903 which transmits the tape drive derived information via transmitter 904 and antenna 905 to transponder 303 of cartridge 300. Alternatively, transponder 303 transmits via a suitably configured antenna, information from memory 304 to transmitter/receiver unit 904 via antenna 905. Crystal oscillator 906 is provided for use with transmitter/receiver unit 904 as is known to those skilled in the art. Following receipt of information from cartridge 300 processor 903 is configured to process the received information accordingly and thereafter pass the received information via interface 902 to a suitably configured media drive reader. Processor 903 further comprises a sensor processing unit 907 which is configured to process sensor derived information transmitted by transponder 303 as obtained from sensor 305 and stored in memory 304.

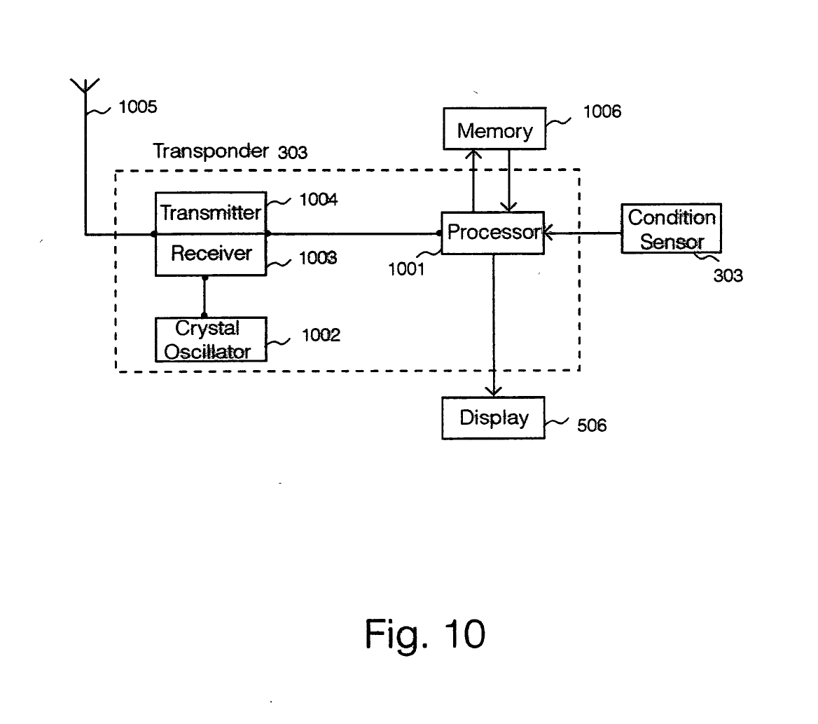

FIG. 10 is a schematic illustration of an alternative embodiment of the tape data storage cartridge of FIG. 3. Transponder unit 303 comprises a processor 1001, crystal oscillator 1002, receiver 1003 and transmitter 1004. Signals are transmitted to read/write device 900 or received from read/write device 900 via antenna 1005. Processor 1001 communicates with memory 1006 so as to store and retrieve information as required. Transponder unit 303 communicates with condition sensor unit 305 as was previously described.

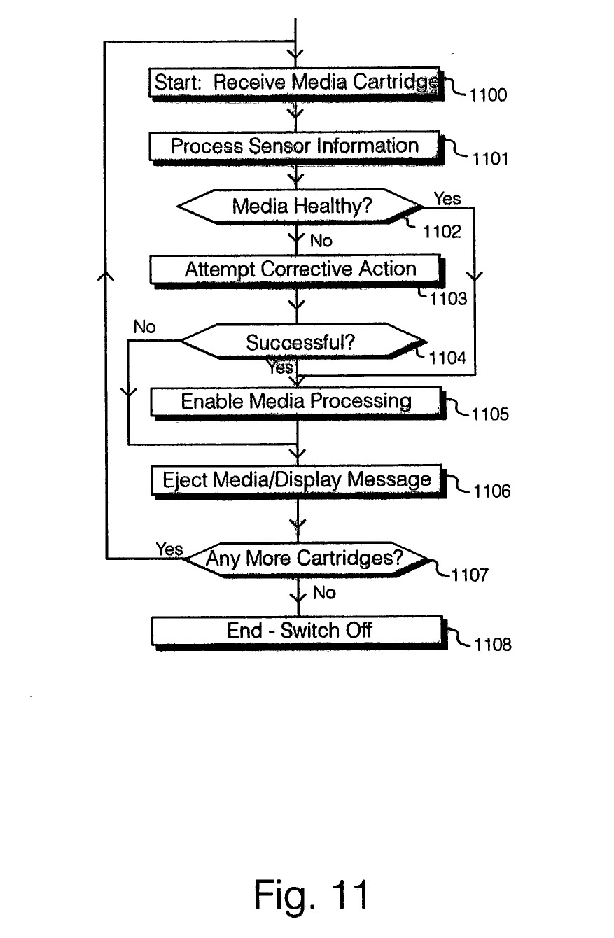

FIG. 11 is a flow diagram of programmed processing steps performed by the media cartridge information reader of FIG. 9. At step 1100 cartridge information reader 900 is receives a signal notifying it that the attached media drive unit has received a new media cartridge. Following step 1100, at step 1101 processor 903 is configured to cause sensor processing unit 907 to process received sensor information. Following step 1101 a question is asked by sensor processing unit 907 as to whether or not the received media cartridge is in a suitably healthy state for continuing processing of the received media cartridge. If the question asked at step 1102 is answered in the affirmative, the program advances to step 1105 wherein sensor processing unit 907 is configured to enable further user required media processing by unit 903 to be continued. However, if the question asked at step 1102 is answered in the negative, sensor processing unit 907 is suitably configured to attempt some form of corrective action at step 1103. Suitable corrective action can be relatively simple to comprise ejection of the media if a problem is identified or can involve various sub-routines attempting re-picking of the tape mechanism so as to determine if the problem can be rectified in some way. The outcome of step 1103 is thus dependent upon particular processing incorporated by a given manufacturer. Following step 1103 a question is asked by processing unit 907 at step 1104 as to whether or not the attempt at corrective action has been successful. If the question asked at step 1104 is answered in the affirmative then sensor processing unit 907 passes control to processor 903 to enable normal media user required processing to be continued at step 1105. If the question asked at step 1104 is in the negative, indicating that medium has been determined to be not suitable for further processing, the program advances from step 1104 to step 1106 and the medium is ejected and/or a suitable display message is displayed on the media reader device. Similarly, if the program advances from step 1104 to 1105 (i.e. if corrective action was successful) and normal processing of the medium is thereby completed, the program advances to step 1106 and a suitable display message is displayed to indicate that processing has been completed. Following step 1106, the program advances to step 1107 wherein a further question is then asked as to whether any more cartridges are required to be processed. If the answer to this question is in the affirmative, the program returns to step 1100 and steps 1100-1107 are repeated accordingly. However, if the question asked at step 1107 is answered in the negative, the process is effectively terminated at step 1108 with sensor processing unit 907 being switched off. As will readily be understood by those skilled in the art, processors 903 and 907 can readily be configured as a single micro-processor and thus the separation into two units is provided for illustrative purposes only.

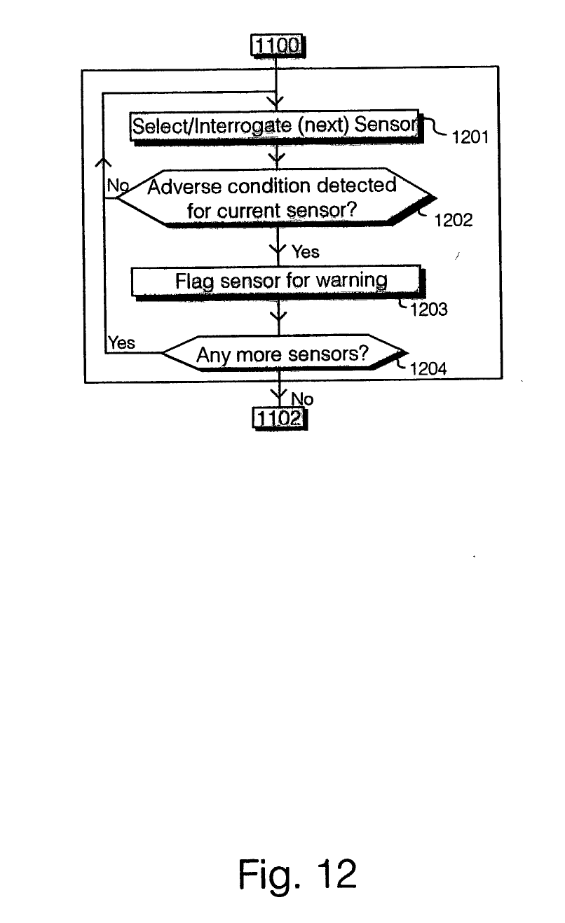

FIG. 12 is a flow diagram of sensor interrogation step 1101 of FIG. 11 as undertaken by sensor processing unit 907 and represents processing of a plurality of sensors configured in a cartridge such as cartridge 300. As discussed previously, a plurality of sensors can be utilized including a shock detector, a humidity detector, a temperature sensor, a radiation sensor and a magnetic field sensor.

At step 1201 processor unit 907 selects and interrogates information from the next sensor configured in a given cartridge. Following step 1201 the cartridge sensor environmental parameter indicated for the selected sensor is interrogated at step 1202 (such as via stored sensor derived information in memory 304). During step 1202 a question is asked, following the interrogation, as to whether an adverse environmental condition has been sensed for the current sensor. If the question asked at step 1202 is answered in the negative, the process is returned to step 1201 and the next sensor is selected for interrogation. However, if the question asked at step 1202 is answered in the affirmative, a suitably configured mechanism is invoked to effectively flag the particular sensor being processed with a warning. Such flagging of a sensor at step 1203 can involve setting a particular byte in a data field with a given value to indicate the medium is damaged by a given environmental condition. The flag is utilized in the display step to cause display of a suitable message at step 1106 of FIG. 11. Following step 1203 the process advances to step 1204 wherein a question is asked as to whether there are any further sensors to be processed. If the question asked at step 1204 is answered in the affirmative then process returns to step 1201 and steps 1201-1204 are repeated accordingly. However, if the question asked at step 1204 is answered in the negative control then advances to step 1102 as previously discussed.

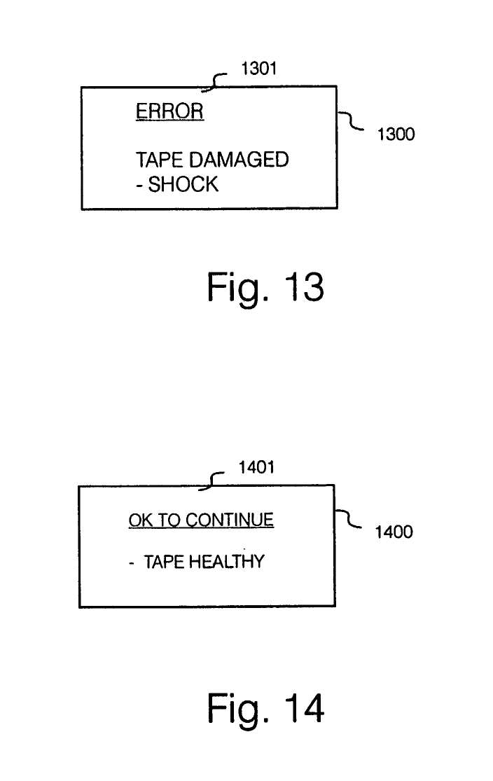

Step 1106 of FIG. 11 involves displaying a message depending upon the outcome of previous processing steps. FIG. 13 is a schematic illustration of an exemplary message on a display screen of a media drive, wherein an error message is displayed (through flagging of a given sensor at step 1203) to the effect that an error has been found. In the example shown, the message 1301 displayed on screen 1300 comprises the wording “Error Tape Damaged—Shock”.

Message 1301 thus informs a user that shock damage to the given media cartridge has been found and that the damage is related to some form of external shock force having been exerted on the cartridge.

FIG. 14 is a schematic illustration of a display screen 1400 of a media drive while a message 1401 is displayed. In the example, message 1401 indicates that the given media now being interrogated has been determined to be satisfactory for continued processing and thus is considered to be healthy and not a risk to damaging the media drive if further processing is undertaken at step 1105 of FIG. 11.

FIG. 15 is a schematic illustration of a media cartridge 1500 comprising a casing and data storage medium such as a magnetic tape and further comprises a transponder unit 1501, memory in cartridge unit 1502 and one or more sensors 1503 as was the case for the media cartridge 300 of FIG. 3. However, media cartridge 1500 additionally comprises a power supply delivery device 1504 in the form of an internal battery of other internal power source configurable to power a display screen 1505 having on/off switch 1506 and display scroll through controller 1507. Controller 1507 may simply comprise a button which can be pressed to scroll through different fields of information or to select various options which are pre-configured for providing user control over information from memory 1502 to be displayed on screen 1505. Thus, cartridge 1500 comprises a processor such as processor 1001 which can also be operated in a similar manner to that described for processing unit 907 but, as those skilled in the art will realize, certain fairly straight forward changes to the steps would be required to achieve scrolling through a display.

FIG. 16 is a schematic illustration of a further preferred embodiment of a shock sensor as configured in a media cartridge 1600 that comprises a casing 1601, shown as a cutaway portion of a surface of the cartridge. Inside casing 1601 is a data storage medium, viz a magnetic tape 1602, and a memory 1603 which is securely fixed to casing 1601. Memory 1603 comprises an interface 1604 for interfacing with a memory reader device 1605. Memory 1603 is electrically connected to a breakable electrically conductive strip 1606 that extends around the inner surface of the cartridge casing 1601. The breakable strip 1606 passes substantially over the central point of the larger planar faces of casing 1601. In operation, if conductive strip 1606 breaks as a result of cartridge 1600 experiencing a force above a predetermined threshold for the strip, the change in electrical conductivity of the strip is recorded by memory 1603. Thereafter, a suitably configured reader device 1605 reads from memory 1603 sensed information concerning the condition of the strip. In FIG. 16, reader device 1605 is external to cartridge 1600 and is in direct electrical connection with interface 1604 via reader device electrical connector pin arrangement 1607. Following detection of the strip having been broken, reader 1605 is configured to transmit a message 1608 to a given user of cartridge 1600 and/or configure a cartridge reader unit comprising reader device 1605 to undertake appropriate recovery action. Appropriate recovery action includes direct ejection of the cartridge from the reader unit or some other appropriate corrective action of the type previously described in relation to FIGS. 11 and 12.

The cartridge illustrated schematically in FIG. 16 can comprise one or more conducting strips of the type shown at 1606. Suitable materials for such conducting strips include metallic electrically conducting foils which are easily deformed and cracked upon a given cartridge being dropped or broken in some way. A break in the conducting path is readily sensed and stored by memory 1603 and thereafter, when appropriate, readily relayed to an appropriately configured memory reader such as reader 1605.

All of the above described cartridges enable some sort of recovery strategy to be adopted to prevent a damaged cartridge from being loaded in a given reader device and prevent the reader drive from being jammed or seriously damaged in some way. The preferred recovery mode can simply include direct ejection of a given media cartridge in response to a given reader device identifying that the cartridge has been damaged in some way such as by experiencing a shock above a predetermined threshold level. Thus, traditionally when a tape cartridge is dropped, the leader pin is usually displaced and packing of the tape disturbed. When such a tape cartridge is loaded into a prior art drive it thereafter jams the drive and causes the drive to fail. The structures of FIGS. 3-16 alleviate this problem in that a user of a cartridge is alerted to the problem before a given tape drive is damaged.

Although an indication of an environmental condition having been experienced by a given cartridge can be indicated by a displayed message, other ways of providing a suitable indication to a user can be employed. For example, a cartridge could be configured to issue a sound which is made by pressing a button, the sound being generated if a cartridge has been damaged. Usage of the term “health” in the present specification and claims is to be construed as the condition of a given cartridge in respect of a given environmental condition sensed. A cartridge that has experienced a shock force, for example, is “unhealthy” in relation to the sensed parameter of shock. The cartridge is also “unhealthy” in relation to one or more other sensed environmental conditions. Of course, in many of the described cartridges, including the cartridges of FIG. 3 and FIG. 15, a particular sensor, such as a shock sensor, might not have sensed a shock as having taken place. In this case, the sensor does not record the fact that a shock has not taken place and therefore the sensor is regarded as having not sensed an adverse environmental condition. However, the fact that the sensor has not sensed anything still constitutes a required indication that the cartridge to which the sensor relates is healthy.

In terms of a shock force sensor, the sensed condition is in effect a deceleration but, for the sake of description, the term acceleration has been used as those skilled in the art will realize. Acceleration is defined as the rate of change of velocity whether this be a negative or a positive quantity.

Media cartridges comprising a memory in cartridge chips as described can be configured with yet a further embodiment of a shock detector. Another example of a shock detector involves making a zone of a memory chip contain tracks made of either exceptionally fine linewidth or of polysilicon or another material of fragile physical strength. The zone functions as a “shock fuse”, i.e., a fuse that breaks when a chip carrying the fuse is subjected to a predetermined amount of excessive shock or vibration. By making the zone contain a series of such tracks of varying width (or physical strength), the magnitude of the shock can be detected by the degree to which the series of fuses is broken. If the cartridge is then inserted into a drive or library, the memory in cartridge can be read without loading or moving the tape. If shock damage is indicated by the fuses and is of sufficient magnitude to suggest that the cartridge, reader or tape is likely to be damaged, the cartridge can be ejected without disturbing the tape, and an error message can be supplied to the user. The cartridge can then be recovered by a specialist service provider who deals with repair or replacement of such cartridges. In such a circumstance, because the tape has not been further damaged by attempts to load it into a given cartridge reader, the data remaining on the tape have the maximum likelihood of being recovered.

In all of the above embodiments it is to be understood that the tape cartridge can include a replaceable shock detector. Thus in the event that a given shock detector is fused, upon analysis of the tape cartridge it can be ascertained that the cartridge is not damaged in a significant way and therefore useable after all.

The various examples and embodiments described above all provide an improvement over existing cartridges and media drives in that a solution is given to users of media cartridges so that a given media cartridge can be pre-checked prior to a given tape data storage medium being utilized by a tape drive. In particular, a sensor is required for detecting shock experienced by a given media cartridge such as a magnetic tape cartridge. By enabling a user to ascertain whether or not a given cartridge has been damaged by a shock force a suitably configured tape drive can be controlled as to whether or not to proceed with processing a tape cartridge. This clearly benefits both cartridge users and suppliers of media drives in that the frequent problems of tape media drive malfunction through damaged tapes are substantially reduced.

1. A media cartridge comprising:
a casing;
a data storage medium for storing data; and
at least one shock sensor for sensing a shock condition experienced by said media cartridge.

2. A media cartridge as claimed in claim 1, wherein said data storage medium comprises a magnetic tape.

3. A media cartridge as claimed in claim 1, wherein said data storage medium comprises a magnetic random access memory.

4. A media cartridge as claimed in claim 1, wherein said data storage medium comprises a rotatable magnetic disk.

5. A media cartridge as claimed in claim 1, further comprising:
a memory device configured to store fields of information including information derived from said at least one sensor; and
an electrical power supply delivery device configurable to enable electrical power to be supplied to said memory device.

6. A media cartridge as claimed in claim 1, further comprising a memory device configured to store fields of information including sensor information derived from said at least one sensor; and
an electrical power supply delivery device configurable to enable electrical power to be supplied to said memory device;
wherein said stored sensor information is configurable to be read by an external reader device.

7. A media cartridge as claimed in claim 1, further comprising a transponder arrangement configurable to transmit sensed information to an external reader device.

8. A media cartridge as claimed in claim 1, wherein said at least one said sensor comprises an accelerometer type device configurable to detect a predetermined amount of force experienced by said media cartridge.

9. A media cartridge as claimed in claim 1, comprising a MEMS based accelerometer.

10. A media cartridge as claimed in claim 1, wherein said sensor is configured to respond to a capacitance change due to an acceleration as a sensed parameter.

11. A media cartridge as claimed in claim 1, wherein said sensor comprises a crystal material arranged to undergo a color change upon experiencing a predetermined acceleration.

12. A media cartridge as claimed in claim 1, wherein said sensor comprises a torsion bar arrangement.

13. A media cartridge as claimed in claim 1, wherein said sensor comprises:
a pedestal about which extends a plurality of torsion bars, said torsion bars being connected to a capacitative plate substantially surrounding said pedestal and said torsion bars.

14. A media cartridge as claimed in claim 1, wherein the sensor includes a breakable electrically conductive strip configured to prevent electrical conduction through said strip in response to a predetermined force being experienced by said media cartridge.

15. A media cartridge as claimed in claim 1, wherein the sensor includes a breakable electrically conductive strip configured to prevent electrical conduction through said strip in response to a predetermined force being experienced by said media cartridge; wherein said strip is fixed to an inner wall of said casing.

16. A media cartridge as claimed in claim 1, wherein the sensor includes a label structure fixed to said casing.

17. A media cartridge as claimed in claim 1, comprising:
a memory device configured to store fields of information including information derived from said at least one sensor;
an electrical power supply delivery device for enabling electrical power to be supplied to said memory device; and
an indicator device for indicating that said sensor has sensed that an adverse shock condition has been experienced by said media cartridge.

18. A media cartridge as claimed in claim 1, further comprising a memory device, the memory device and the sensor being arranged so that in response to said sensor detecting a sensed shock condition, a signal is stored in said memory and said memory is configured to be read by an external reader device.

19. A media cartridge as claimed in claim 1, wherein said sensor comprises a zone of said memory device comprising at least one track of a material configured to break at a predetermined amount of applied shock force.

20. A media cartridge as claimed in claim 1, wherein said sensor comprises a series of tracks, each said track being configured to break at different predetermined amounts of applied shock force.

21. A media cartridge as claimed in claim 1, wherein said sensor comprises at least one track of a polysilicon material configured to break at a predetermined amount of applied shock force.

22. A media cartridge as claimed in claim 1, wherein said sensor is configured to be replaceable.

23. A reader device for interrogating a media cartridge having at least one shock sensor for sensing a shock condition, said media cartridge being capable of storing data describing a shock condition experienced by said media cartridge, said reader device comprising:
a casing;
a reader for reading shock condition data; and
an analyser device for determining, from said read data, whether or not said data storage device has experienced an adverse shock condition.

24. A reader device according to claim 23, further comprising a corrective action unit for attempting corrective action to be undertaken in respect of a said media cartridge, said corrective action being undertaken in response to an output of said analyser indicating that said media cartridge has experienced a said adverse shock condition.

25. A reader device as claimed in claim 23, further comprising an ejector for ejecting said medium cartridge from said reader device prior to said reader device attempting to read data stored on said medium cartridge.

26. A method of checking the health of a medium cartridge including a casing and a data storage medium for storing data, said method comprising
sensing and recording within said cartridge, data describing at least one environmental condition experienced by said cartridge;
reading said at least one recorded environmental condition data from said cartridge; and
determining, from said at least one read environmental condition data, a condition of said medium cartridge.

27. The method as claimed in claim 26, wherein said step of reading said recorded shock condition data from said cartridge is performed by a reader device which is independent of said cartridge.

28. A medium cartridge comprising:
a casing;
a data storage medium for storing data; and
a solid state accelerometer for sensing a shock force experienced by said medium cartridge.

29. A medium cartridge comprising:
a casing;
a memory device, said memory device having an interface portion interfacing with a reader device; and
an electrically conducting strip wherein said strip is configured to break and thereby prevent electrical conduction in response to said cartridge experiencing a shock force which is higher than a predetermined shock force associated with breaking said strip, said strip being in electrical communication with said memory device for enabling said memory device to store an indication of the condition of said strip.

30. The medium cartridge as claimed in claim 29, configured to be read by an external memory reader.

31. A medium cartridge as claimed in claim 1, further comprising a memory device configured to store fields of information including sensor information derived from said at least one sensor; and
an electrical power supply delivery device for supplying electric power to said memory device.

32. A medium cartridge as claimed in claim 1, further comprising a transponder arrangement for transmitting sensed information to an external reader device.

33. A medium cartridge as claimed in claim 32, wherein the sensed information includes the sensed shock condition.

34. A reader device as claimed in claim 25, wherein the ejector is coupled with the analyzer for causing cartridge ejection in response to the analyzer determining that the data storage device has experienced an adverse shock condition.

35. In a method of determining an environmental characteristic of a medium cartridge comprising a casing and a data storage medium for storing data, said method comprising
sensing and recording within said cartridge, data describing an environmental condition experienced by said cartridge.

36. A method according to claim 26 wherein the at least one environmental condition includes shock.

37. A method according to claim 35 wherein the at least one environmental condition includes shock.

38. A method according to claim 26 wherein the at least one environmental condition includes temperature.

39. A method according to claim 35 wherein the at least one environmental condition includes temperature.

40. A method according to claim 26 wherein the at least one environmental condition includes magnetism.

41. A method according to claim 35 wherein the at least one environmental condition includes magnetism.

42. A method according to claim 26 wherein the at least one environmental condition includes humidity.

43. A method according to claim 35 wherein the at least one environmental condition includes humidity.
